(19) United States
(12) Patent Application Publication
(10) Pub. No.: US 2002/0056966 A1
(43) Pub. Date: May 16, 2002

(54) Flexible ski support system

(76) Inventor: Dale D. Cormican, Mentor, MN (US)

Correspondence Address: Curtis V. Harr, P. O. Box 2842, Fargo, ND, 58108-2842, US

(21) Appl. No.: 09/999,795

(22) Filed: Oct. 31, 2001

Related U.S. Application Data
(63) Continuation-in-part of application No. 09/130,892, filed on Aug. 7, 1998.
(63) Continuation-in-part of application No. 09/935,080, filed on Aug. 21, 2001.

(51) Int. Cl. B62M 27/00; A63C 5/00

(52) U.S. Cl. 280/22; 280/601

(57) ABSTRACT

A flexible ski support system for increasing the overall flexibility of a snowmobile ski through the elimination of a metal saddle. The flexible ski support system consists of a ski having an elongate body and a support portion having a first member and a second member, a first aperture extending within the first member, a second aperture extending within the second member, a first bushing member positioned within the first aperture, and a second bushing member positioned within the second aperture. The elongate body and the support portion are both molded into a one-piece structure from a relatively highly flexible material such as plastic. The bushing members each have a concentric bore for receiving a connecting pin for allowing attachment to a suspension arm of a snowmobile. The bushing members distribute the vertical and horizontal forces over a relatively broad area within the support portion thereby preventing damage or breakage to the support portion.

### CROSS-REFERENCE TO RELATED U.S. PATENT APPLICATION

I hereby claim benefit under Title 35, United States Code, Section 120 of U.S. patent applications Ser. No. 09/130,892 filed Aug. 7, 1998 and Ser. No. 09/935,080 filed on Aug. 21, 2001. This application is a continuation-in-part of the 09/130,892 and 09/935,080 applications. The 09/130,892 and 09/935,080 applications are currently pending. The 09/130,892 and 09/935,080 applications are hereby incorporated by reference into this patent application.

### BACKGROUND OF THE INVENTION

1. Field of the Invention

The present invention relates generally to support and attachment devices for skis for use upon snowmobiles and like vehicles that operate upon snow, and more specifically it relates to a flexible ski support system for increasing the overall flexibility of a snowmobile ski through the elimination of a metal saddle.

2. Description of the Prior Art

Skis for snowmobiles and like vehicles have been in use for years. A snowmobile or like vehicle typically is comprised of a frame, a track within the rear portion of the vehicle, and a pair of skis controllably attached to a steering structure of the vehicle. Skis are utilized for supporting and steering the vehicle during operation upon snow and other surfaces.

Recently, skis for snowmobiles and like vehicles have been constructed of a combination metal and resilient plastic, such as ultra high molecular weight (UHMW) polyethylene, which allows for increased flexibility of the ski when encountering obstacles. The main body of the ski is comprised of a plastic material typically manufactured utilizing injection molding or blow molding wherein the rear portion to middle portion is molded relatively straight with the front portion molded to possess the desired curvature without stress existing within the front portion. A rigid metal “saddle” is attached to the middle portion of the plastic ski for allowing attachment of the ski to the front suspension of the snowmobile. A connecting pin is attached between the front suspension of the snowmobile and the metal saddle. A loop member, typically constructed of plastic, is attached to the front end of the ski and then to the middle portion of the ski with no stress contained within the front portion thereof.

The main problem with conventional plastic skis is that they utilize a rigid metal saddle that extends along a middle portion of the body of the ski a finite distance at the central flexing point of the ski thereby significantly reducing the ability of the ski to flex when encountering obstacles. Because the rigid metal saddle is positioned at the central flexing point of the ski, the front and rear portions of the ski must receive a significant portion of the flexing action of the ski during operation of the snowmobile. As is well known, when portions of the plastic ski are placed at greater stress, it becomes increasingly difficult to further bend/flex the ski thereby providing a “rougher” ride for the snowmobile rider.

In these respects, the flexible ski support system according to the present invention substantially departs from the conventional concepts and designs of the prior art, and in so doing provides an apparatus primarily developed for the purpose of increasing the overall flexibility of a snowmobile ski.

### SUMMARY OF THE INVENTION

In view of the foregoing disadvantages inherent in the known types of skis now present in the prior art, the present invention provides a new flexible ski support system wherein the same can be utilized for increasing the overall flexibility of a snowmobile ski through the elimination of a metal saddle.

The general purpose of the present invention, which will be described subsequently in greater detail, is to provide a new flexible ski support system that has many of the advantages of the skis mentioned heretofore and many novel features that result in a new flexible ski support system which is not anticipated, rendered obvious, suggested, or even implied by any of the prior art, either alone or in any combination thereof.

To attain this, the present invention generally comprises a ski having an elongate body and a support portion having a first member and a second member, a first aperture extending within the first member, a second aperture extending within the second member, a first bushing member positioned within the first aperture, and a second bushing member positioned within the second aperture. The elongate body and the support portion are both molded into a one-piece structure from a relatively highly flexible material such as plastic. The bushing members each have a concentric bore for receiving a connecting pin for allowing attachment to a suspension arm of a snowmobile. The bushing members distribute the vertical and horizontal forces over a relatively broad area within the support portion thereby preventing damage or breakage to the support portion.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a flexible ski support system that will overcome the shortcomings of the prior art devices.

A second object is to provide a flexible ski support system for increasing the overall flexibility of a snowmobile ski through the elimination of a metal saddle.

Another object is to provide a flexible ski support system that allows the entire body of the snowmobile ski to freely flex during operation.

An additional object is to provide a flexible ski support system that increases the overall performance of the ski in a variety of conditions.

A further object is to provide a flexible ski support system that eliminates the requirement and usage of a rigid metal saddle upon a snowmobile ski.

A further object is to provide a flexible ski support system that reduces stresses commonly applied at locations in front and behind a rigid metal saddle within a conventional snowmobile ski.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention illustrating the connection of the snowmobile suspension arm to the ski without the usage of a rigid metal saddle.

FIG. 2 is a magnified exploded upper perspective view of the present invention.

FIG. 3 is a magnified top view of the present invention with the connecting pin securely positioned within.

FIG. 4 is a cross sectional view taken along line 4-4 of FIG. 3 illustrating the first and second bushings within the support portion of the ski.

FIG. 5 is an exploded top view of the present invention.

FIG. 6 is a cross sectional view taken along line 6-6 of FIG. 5.

FIG. 7 is a top view of the present invention illustrating the non-usage of a metal saddle.

FIG. 8 is a cross sectional view taken along line 8-8 of FIG. 7.

FIG. 9 is an outer perspective view of a bushing member.

FIG. 10 is an inner perspective view of a bushing member.

FIG. 11 an end view of the bushing member from the flanged side.

FIG. 12 is an end view of the bushing member from the main body side.

FIG. 13 is a side view of the bushing member.

FIG. 14 is an exploded top view of another arrangement of the bushing members wherein the bushing members extend into the support portion of the ski from the outside.

FIG. 15 is an upper perspective view of an alternative embodiment of the bushing members without a flanged portion.

FIG. 16 is a side view of the alternative embodiment of the bushing members.

### DESCRIPTION OF THE PREFERRED EMBODIMENT

### A. Overview

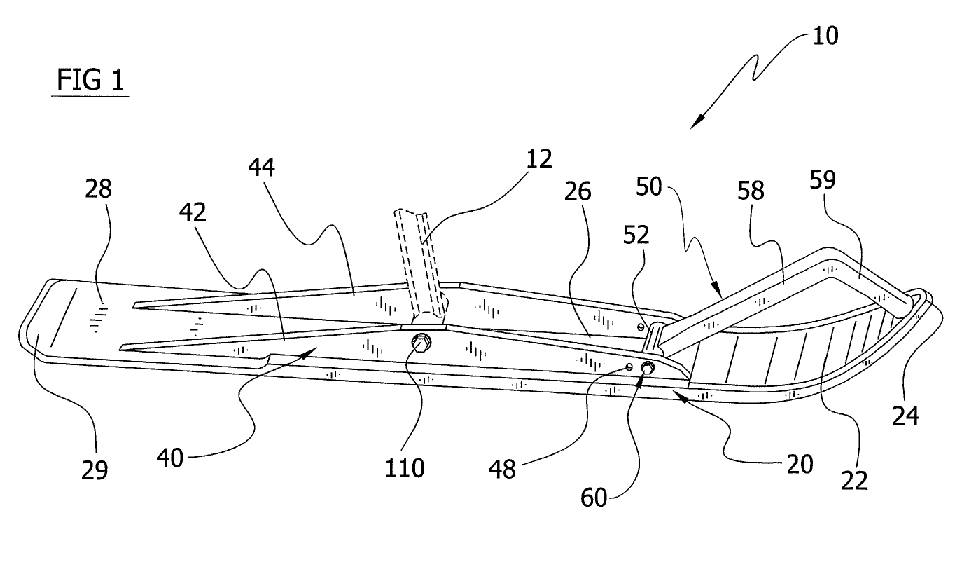

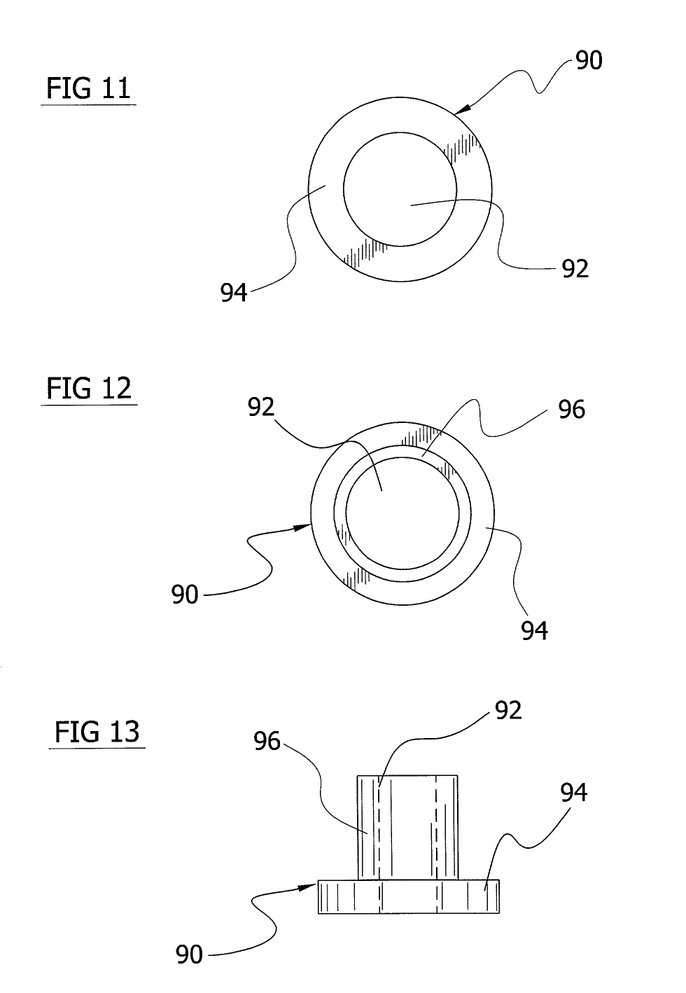

Turning now descriptively to the drawings, in which similar reference characters denote similar elements throughout the several views, FIGS. 1 through 16 illustrate a flexible ski support system 10, which basically comprises a ski having an elongate body 20 and a support portion 40 having a first member and a second member, a first aperture 70 extending within the first member, a second aperture 80 extending within the second member, a first bushing member 90 positioned within the first aperture 70, and a second bushing member 100 positioned within the second aperture 80. The elongate body 20 and the support portion 40 are both molded into a one-piece structure from a relatively highly flexible material such as plastic. The bushing members each have a concentric bore 92, 102 for receiving a connecting pin 110 for allowing attachment to a suspension arm 12 of a snowmobile. The bushing members distribute the vertical and horizontal forces over a relatively broad area within the support portion 40 thereby preventing damage or breakage to the support portion 40.

### B. Elongate Body

The elongate body 20 is preferably comprised of a resilient and flexible material such as but not limited to ultra high molecular weight (UHMW) polyethylene. It can be appreciated that various other types of resilient and flexible materials may be utilized to construct the elongate body 20. Furthermore, the elongate body 20 may be created utilizing various molding processes such as but not limited to injection molding. Once the elongate body 20 has solidified, the elongate body 20 is removed from the respective mold by various conventional removal means.

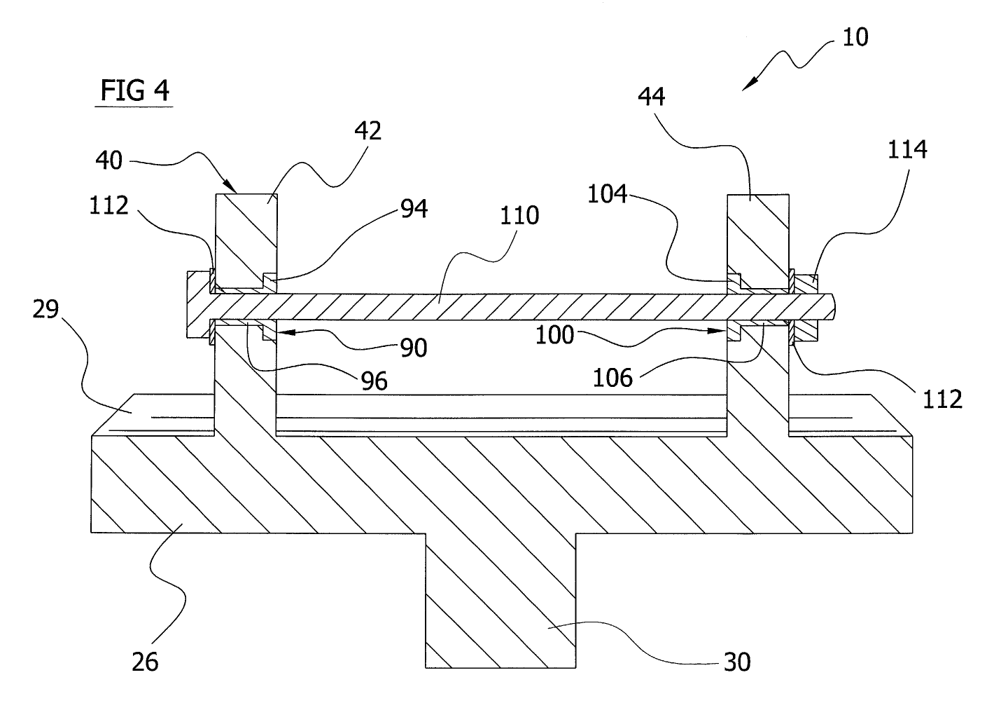

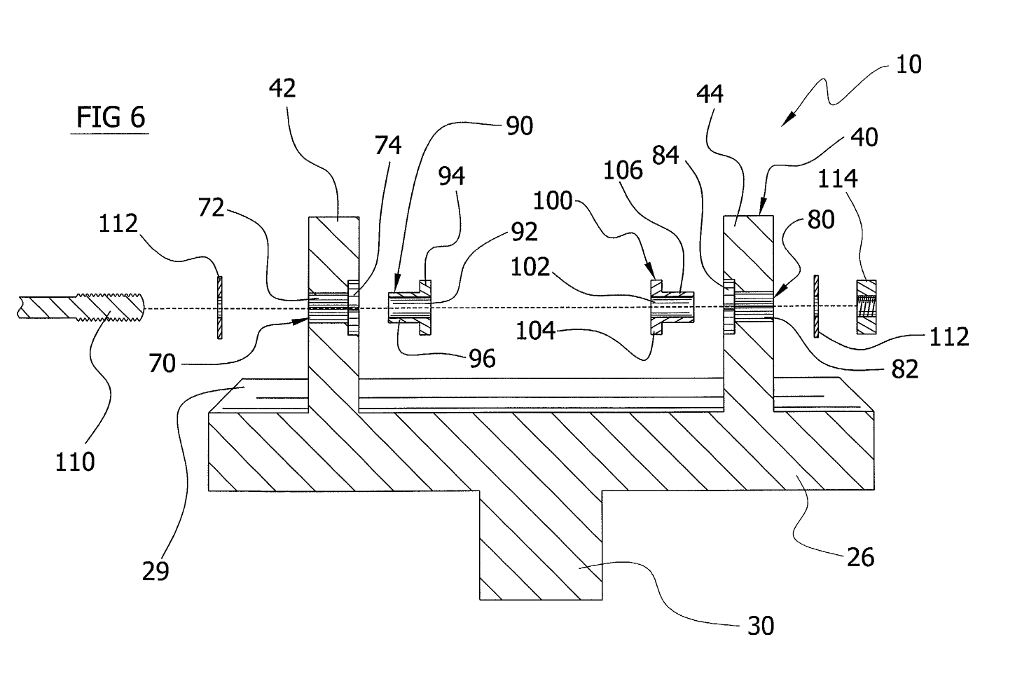

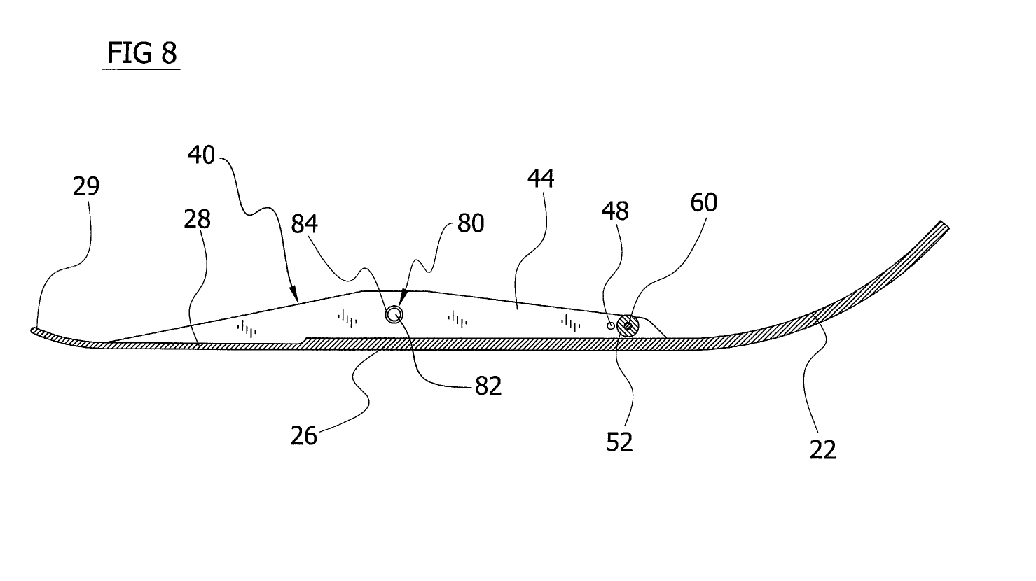

As further shown in FIGS. 1, 7 and 8 of the drawings, the elongate body 20 is basically comprised of a front portion 22 having a front end 24, a middle portion 26 and a rear portion 28 having a rear end 29. The rear portion 28, middle portion 26 and the front portion 22 define a substantially straight structure having a longitudinal axis extending from the rear portion 28 to the middle portion 26 of the elongate body 20, wherein the longitudinal axis is parallel to the upper surface of the middle portion 26 of the elongate body 20. The elongate body 20 has a generally flat structure except for the support portion 40 and the keel member 30 as best illustrated in FIGS. 4 and 6 of the drawings. It can be appreciated that the elongate body 20 may have various shapes other than a flat shape that is able to act as a ski. The elongate body 20 has an upper surface and a lower surface which are substantially parallel to one another which may have a varying or consistent thickness throughout. As shown in FIG. 8 of the drawings, the rear end 29 of the rear portion 28 is preferably curved for allowing the elongate body 20 to move rearwardly without catching upon the surface. However, it can be appreciated that the rear end 29 may have various other shapes such as but not limited to straight and slanted. At least one keel member 30 preferably extends from a lower surface of the elongate body 20 that is utilized for increasing the steering abilities of the finalized product. The keel member 30 may extend from or near the rear end 29 to the front portion 22 of the elongate body 20. The keel member 30 is preferably centered within the lower surface of the elongate body 20, however it can be appreciated that various other locations upon the elongate body 20 may be utilized particularly if multiple keel members 30 are utilized. The keel member 30 is preferably parallel to the longitudinal axis of the elongate body 20. The keel member 30 is preferably molded within the elongate body 20, however the keel member 30 may be removably attached thereto. In addition, the keel member 30 is preferably formed for receiving a wear rod member (not shown) commonly utilized upon snowmobile skis and the like for reducing wear upon the keel member 30 and the elongate body 20 during usage.

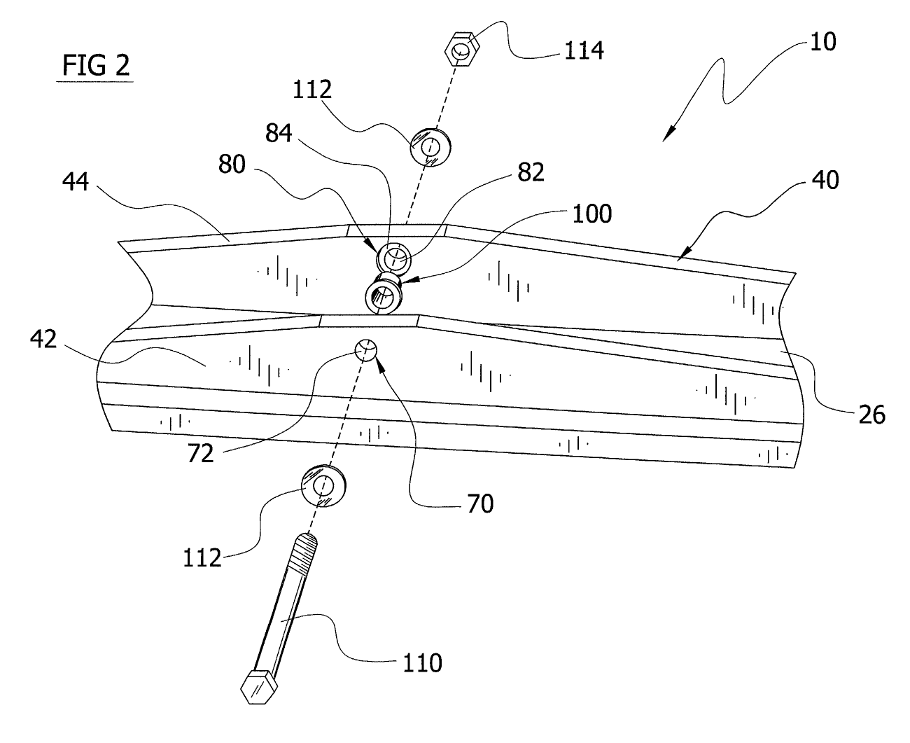

As shown in FIGS. 1 and 2 of the drawings, a support portion 40 extends upwardly from the upper surface of the elongate body 20 and is preferably molded integral within the elongate body 20. The support portion 40 is also comprised of the same material as the elongate body 20 or material having similar physical properties for allowing flexing thereof.

The support portion 40 extends from the middle portion 26 of the elongate body 20 thereby substantially defining the middle portion of the elongate body 20 with the front portion 22 and the rear portion 28 on opposing ends of the support portion 40. The middle portion 26 may extend a finite distance past the distal ends of the support portion 40 as can be appreciated. The boundaries of the middle portion 26 therefore should not be limited to the area of the elongate body 20 supporting the support portion 40. It should be noted that the terminology front portion 22, middle portion 26 and rear portion 28 are merely utilized to illustrate the present invention and should not limit the scope of the invention.

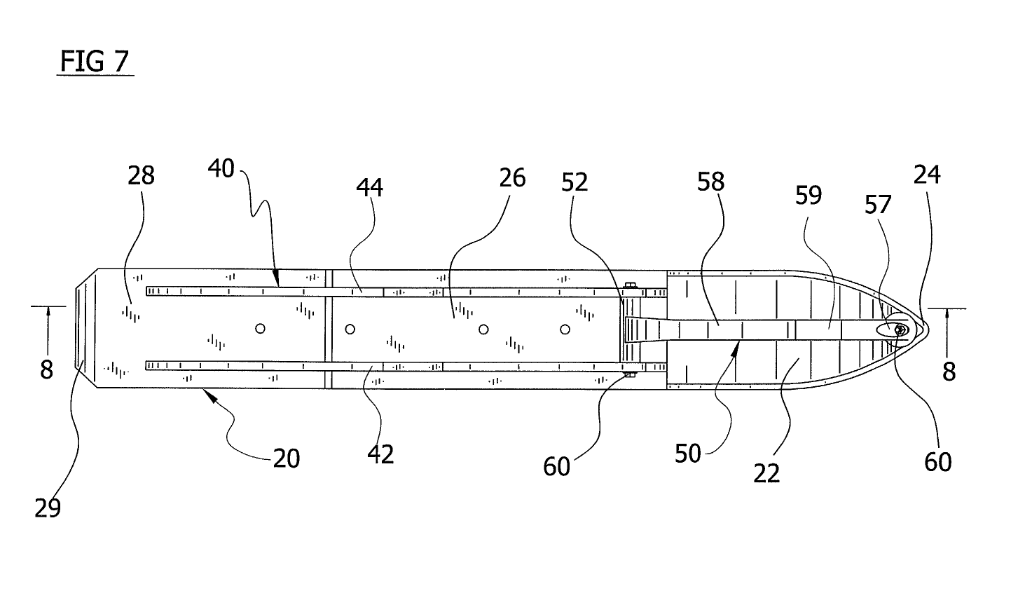

The support portion 40 is preferably comprised of a first portion 42 and a second portion 44 extending substantially parallel to one another in a distally spaced relationship as is best illustrated in FIG. 7 of the drawings. The first portion 42 and the second portion 44 are preferably substantially traverse to the upper surface of the elongate body 20 as shown in FIGS. 4 and 6 of the drawings. The first portion 42 and the second portion 44 each have a defined width that may be consistent or non-consistent through the entire length of the support portion 40. In addition, the first portion 42 and the second portion 44 each have an inner surface and an outer surface as further shown in the figures. The support portion 40 may have various shapes and structures other than that illustrated within the drawings.

At least one pair of receiving apertures 48 extend through the support portion 40 in opposition to one another adjacent the front portion 22 of the elongate body 20 as further shown in FIGS. 1 and 8 of the drawings. More than one pair of receiving apertures 48 is preferably utilized for allowing for the adjustment of the preload member 50. The receiving apertures 48 are formed for receiving at least one fastener 60 extending through the preload member 50 for securing the preload member 50 to the middle portion 26 of the elongate body 20. It can be appreciated that various other connection means may be utilized to secure the preload member 50 to the middle portion 26 of the elongate body 20 and the illustration of the receiving apertures 48 should not limit the scope of the invention. For example, the preload member 50 may be attached nonmovably or movably to the middle portion 26 of the elongate body 20 without being attached directly to the support portion 40.

### C. Bushing Apertures

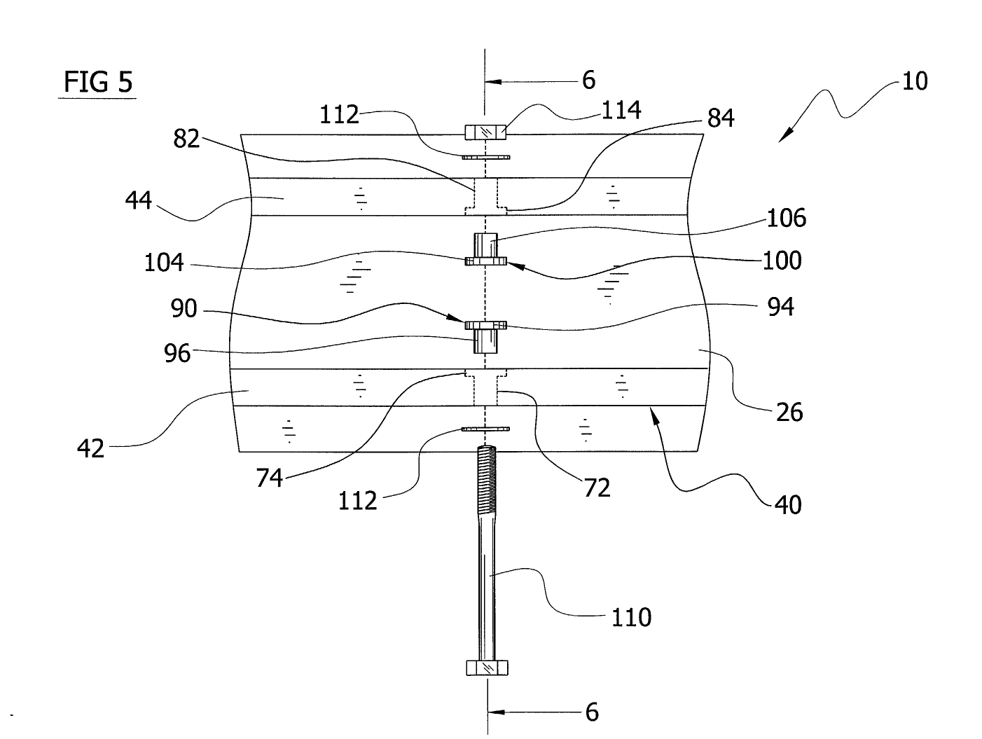

As shown in FIGS. 5, 6 and 14 of the drawings, a first aperture 70 extends within the first portion 72, 82 from the inner surface to the outer surface thereof. The first aperture 70 extends completely through the first portion 42 of the support portion 40 as best shown in FIG. 6 of the drawings.

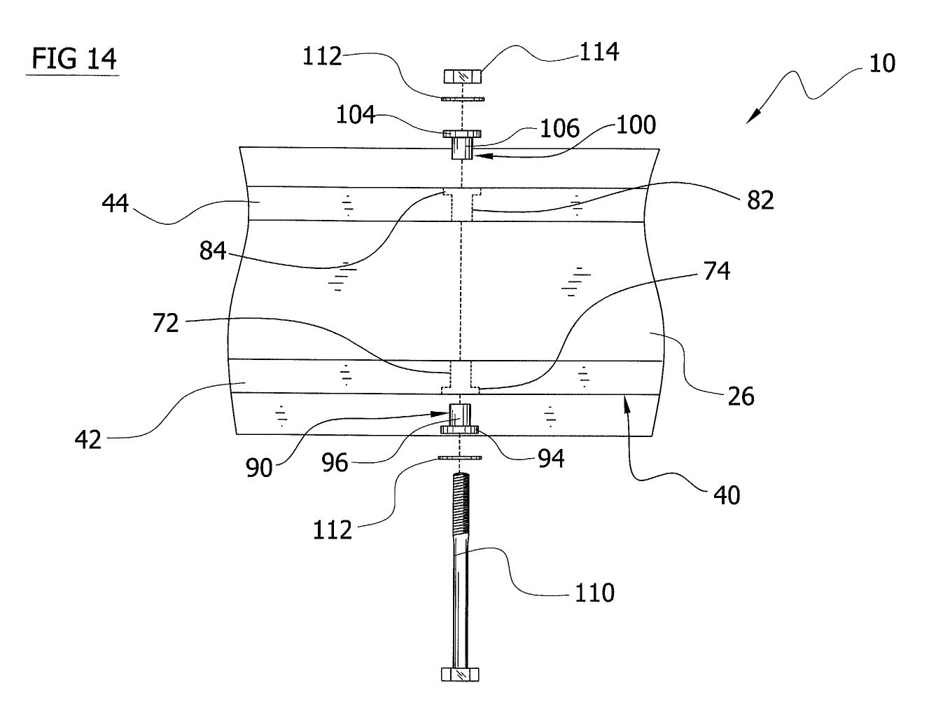

As shown in FIGS. 5, 6 and 14 of the drawings, a second aperture 80 extends within the second portion 44 from the inner surface to the outer surface thereof. The second aperture 80 extends completely through the second portion 44 of the support portion 40 as best shown in FIG. 6 of the drawings. The second aperture 80 is preferably concentric with the first aperture 70 as shown in FIGS. 5 and 14 of the drawings. The second aperture 80 preferably has the same inner diameter as the first aperture 70.

The apertures 70, 80 may be formed within the support portion 40 by various means such as but not limited to by drilling into the support portion 40 with a drill bit. The apertures 70, 80 may also be directly formed within the support portion 40 during the molding process.

As shown in FIGS. 5, 6 and 14 of the drawings, the first aperture 70 and the second aperture 80 preferably each have a first portion 72 having a first width and a second portion 74, 84 having a second width wherein the second width is larger than the first width. The second portion 74, 84 of the apertures 70, 80 extends a finite distance into the support portion 40 concentric with the first portion 42 thereof as best shown in FIGS. 5, 6 and 14 of the drawings. FIGS. 5 and 6 illustrate the second portion 74, 84 as extending into the inner surface of the first portion 42 and the second portion 44 of the support portion 40. FIG. 14 illustrates the second portion 74, 84 extending into the outer surface of the first portion 42 and the second portion 44 of the support portion 40. It can be appreciated that the second portion 74, 84 may extend into both the inner surface and the outer surface of the respective portions 42, 44 thereby allowing two bushing members to be attached to each of the respective portions 42, 44. The second portion 74, 84 of the apertures 70, 80 is preferably similar in shape to the first portion 72, 82 of the apertures 70, 80, however differing shapes may be utilized to construct the second portion 74, 84.

The first aperture 70 and the second aperture 80 are preferably comprised of a circular shape. However, various other shapes may be utilized to construct the apertures 70, 80 such as but not limited to rectangular, square, triangular, oval, hexagonal, conical, tapered and various other well-known shapes. In addition, grooves and various other structures may extend into the apertures 70, 80 for various reasons.

### D. Bushing Members

As shown in FIG. 4 of the drawings, a first bushing member 90 is positioned within the first aperture 70, and a second bushing member 100 is positioned within the second aperture 80. It can be appreciated that the bushing members 90, 100 are preferably formed form snugly fitting within the apertures 70, 80 respectively. The bushing members 90, 100 are preferably comprised of a rigid material such as but not limited to metal.

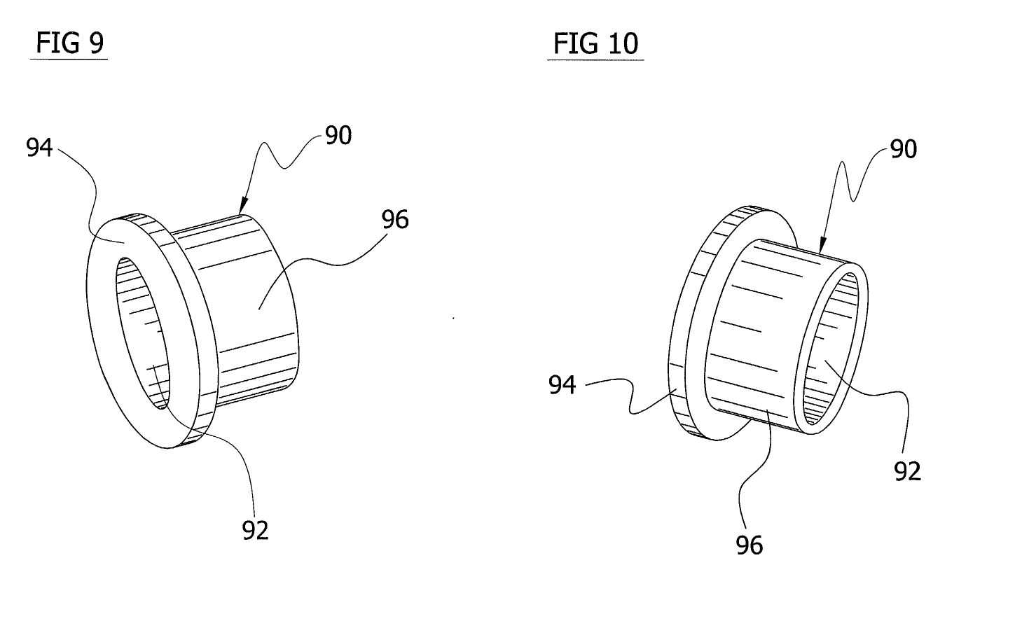

As shown in FIGS. 4, 5, 6 and 14 of the drawings, the first bushing member 90 and the second bushing member 100 each have a first segment 96, 106 corresponding to the first portion 72, 82 42. The first bushing member 90 and the second bushing member 100 each have a second segment 94, 104 corresponding to the second portion 74, 84 of the apertures. The first segment 96, 106 preferably extends completely through the first portion 72, 82 of the respective aperture 70, 80 in a flush manner, however the first segment 96, 106 may be recessed or extend outwardly from the first portion 42 or second portion 44. FIGS. 9 through 13 illustrate the structure of the first bushing member 90 which is similar to the structure of the second bushing member 100. As shown in FIGS. 9, 10 and 13 of the drawings, the second segment 94, 104 is a flanged portion that extends outwardly in a substantially radial manner from the first segment 96, 106. It can be appreciated that the second segment 94, 104 may have various other shapes and structures to accomplish a similar structure.

As shown in FIGS. 6, 9, 10, 11, 12 and 13 of the drawings, each of the bushing members 90, 100 has a bore 92, 102 concentrically positioned within for receiving a connecting pin 110. The bore 92, 102 allows the connecting pin 110 to extend through the bushing members 90, 100 in a relatively tight manner as best shown in FIG. 4 of the drawings. The connecting pin 110 extends through a coupler within a suspension arm 12 upon the front suspension of the vehicle thereby connecting the ski to the vehicle in a pivotal manner. As is well known in the art, the connecting pin 110 may have a threaded portion for receiving a mount nut 114 or other connection apparatus for securing upon a suspension arm 12. One or more washers 112 and mount nuts 114 may also be utilized in further securing the ski to the suspension arm 12 of the vehicle.

As illustrated within the figures, the second segment 94, 104 of the first bushing member 90 is positioned relatively opposite the second segment 94, 104 of the second bushing member 100 and the first segment 96, 106 of the first bushing member 90 is positioned relatively opposite the first segment 96, 106 of the second bushing member 100. However, it can be appreciated that the bushing members 90, 100 may be aligned in a similar manner with one another not illustrated within the figures.

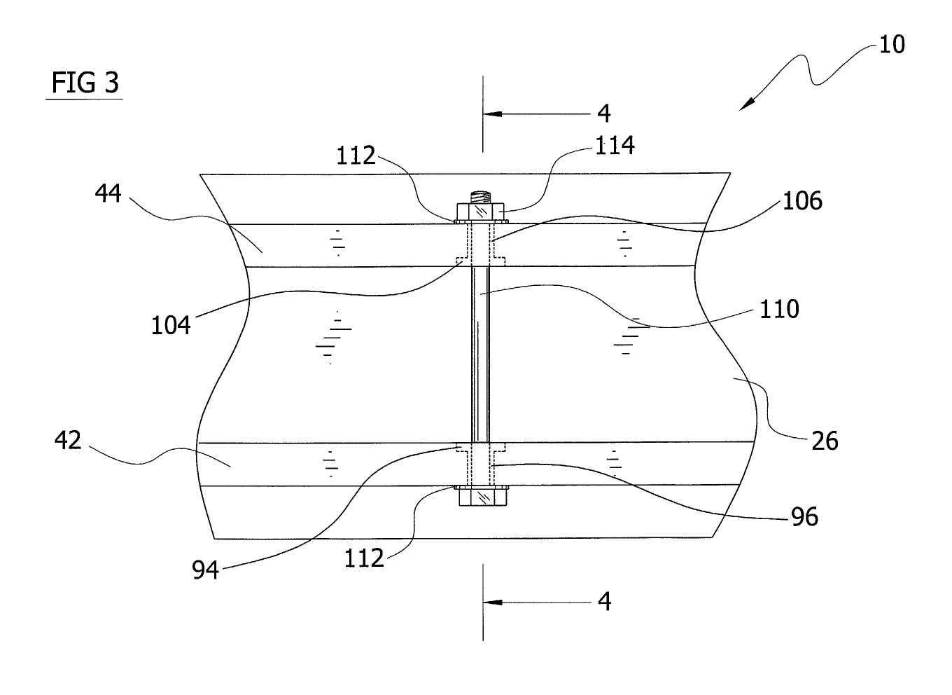

As shown in FIGS. 3 and 4 of the drawings, the second segment 94, 104 of the bushing members is preferably substantially flush with a surface of the first portion 42 and the second portion 44. However, the second segment 94, 104 of the bushing members 90, 100 may extend past a surface of the first portion 42 and the second portion 44.

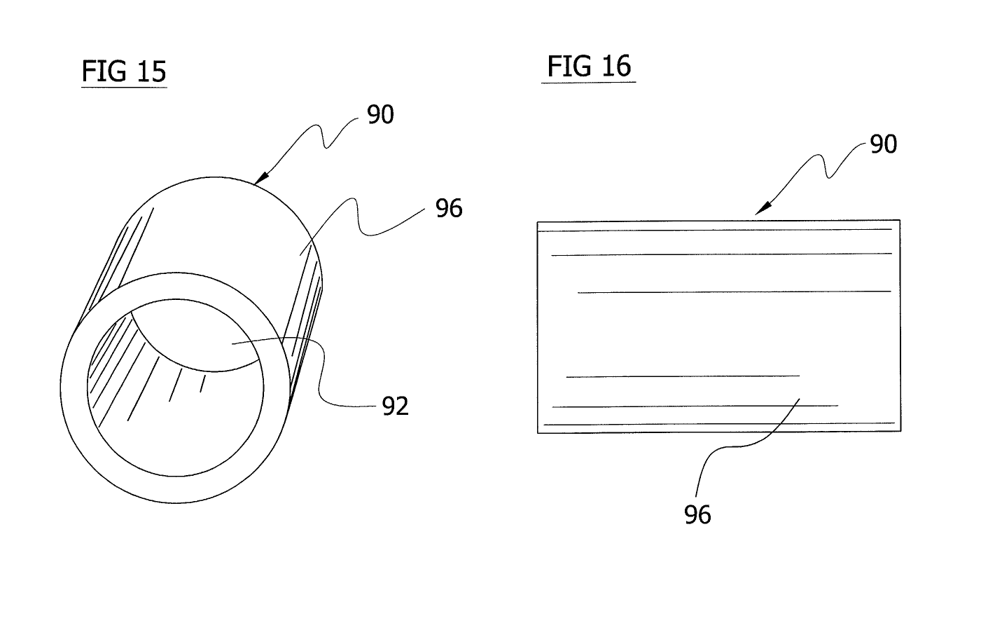

As shown in FIGS. 15 and 16 of the drawings, the bushing members 90, 100 may have a consistent circular structure without the second segment 94, 104 extending from thereof. The apertures 70, 80 would have a similar consistent inner diameter for receiving the bushing members 90, 100 as shown in FIGS. 15 and 16 of the drawings. It can be appreciated that the bushing members 90, 100 may have various shapes and structures that can be positioned within an aperture 70, 80 such as but not limited to conical, tapered, square, triangular, rectangular and hexagonal.

As to a further discussion of the manner of usage and operation of the present invention, the same should be apparent from the above description. Accordingly, no further discussion relating to the manner of usage and operation will be provided. Although the present invention has been described in considerable detail with reference to certain preferred versions thereof, other versions are possible. It should also be stated at this point that although this invention is described in the context of a snowmobile, this invention would be equally useful on airplane skis, BOMBARDIERS, SNO-SCOOTS, and other similar vehicles.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Flexible Ski Support System

□ 10. Flexible Ski Support System
□ 11.
□ 12. Suspension Arm
□ 13.
□ 14.
□ 15.
□ 16.
□ 17.
□ 18.
□ 19.
□ 20. Elongate Body
□ 21.
□ 22. Front Portion
□ 21
□ 23.
□ 24. Front End
□ 25. Front Aperture
□ 26. Middle Portion
□ 27.
□ 28. Rear Portion
□ 29. Rear End
□ 30. Keel Member
□ 31.
□ 32.
□ 33.
□ 34.
□ 35.
□ 36.
□ 37.
□ 38.
□ 39.
□ 40. Support Portion
□ 41.
□ 42. First Portion
□ 43.
□ 44. Second Portion
□ 45.
□ 46. Main Aperture
□ 47.
□ 48. Receiving Apertures
□ 49.
□ 50. Preload Member
□ 51.
□ 52. First End
□ 53.
□ 54.
□ 55.
□ 56. Second End
□ 57. Second Opening
□ 58. First Segment
□ 59. Second Segment
□ 60. Fastener
□ 61.
□ 62.
□ 63.
□ 64.
□ 65.
□ 66.
□ 67.
□ 68.
□ 69.
□ 70. First Aperture
□ 71.
□ 72. First Portion
□ 73.
□ 74. Second Portion
□ 75.
□ 76.
□ 77.
□ 78.
□ 79.
□ 80. Second Aperture
□ 81.
□ 82. First Portion
□ 83.
□ 84. Second Portion
□ 85.
□ 86.
□ 87.
□ 88.
□ 89.
□ 90. First Bushing Member
□ 91.
□ 92. Bore
□ 93.
□ 94. Second Segment
□ 95.
□ 96. First Segment
□ 97.
□ 98.
□ 99.
□ 100. Second Bushing Member
□ 101.
□ 102. Bore
□ 103.
□ 104. Second Segment
□ 105.
□ 106. First Segment
□ 107.
□ 108.
□ 109.
□ 110. Connecting Pin
□ 111.
□ 112. Washer
□ 113.
□ 114. Mount Nut
□ 115.
□ 116.
□ 117.
□ 118.
□ 119.

I claim:

1. A flexible ski for use on a vehicle, said ski comprising:
a molded one piece flexible elongate ski having an upper surface, a bottom surface, and a first portion and a second portion extending upwardly from said upper surface, said first portion and said second portion are spaced apart from each other;
a first aperture within said first portion;
a second aperture within said second portion concentric with said first aperture and opposite said first aperture;
a first bushing member positioned within said first aperture;
a second bushing member positioned within said second aperture; and
wherein said first aperture and said second aperture each have a first portion having a first width and a second portion having a second width wherein said second width is larger than said first width, and wherein said first bushing member and said second bushing member each have a first segment corresponding to said first portion and a second segment corresponding to said second portion of said apertures, wherein said second segment of said first bushing member is positioned relatively opposite said second segment of said second bushing member and wherein said first segment of said first bushing member is positioned relatively opposite said first segment of said second bushing member.

2. The flexible ski for use on a vehicle of claim 1, wherein said flexible elongate ski is comprised of a flexible plastic material.

3. The flexible ski for use on a vehicle of claim 1, wherein said flexible elongate ski is comprised of ultra high molecular weight polyethylene.

4. The flexible ski for use on a vehicle of claim 1, wherein said second portion of said apertures is within an inside portion of said first portion and said second portion.

5. The flexible ski for use on a vehicle of claim 1, wherein said second portion of said apertures is within an outside portion of said first portion and said second portion.

6. The flexible ski for use on a vehicle of claim 1, wherein said first aperture and said second aperture have a circular shape, and wherein said first bushing member and said second bushing member have an outer circular shape corresponding to said apertures.

7. The flexible ski for use on a vehicle of claim 1, wherein said first aperture and said second aperture have a rectangular shape, and wherein said first bushing member and said second bushing member have an outer rectangular shape corresponding to said apertures.

8. The flexible ski for use on a vehicle of claim 1, wherein said bushing members are comprised of a metal material.

9. The flexible ski for use on a vehicle of claim 1, wherein said second segment of said bushing members is substantially flush with a surface of said first portion and said second portion.

10. The flexible ski for use on a vehicle of claim 1, wherein said second segment of said bushing members extends past a surface of said first portion and said second portion.

11. A flexible ski for use on a vehicle, said ski comprising:
a molded one piece flexible elongate ski having an upper surface, a bottom surface, and a first portion and a second portion extending upwardly from said upper surface, said first portion and said second portion are spaced apart from each other;
a first aperture within said first portion having a first inner diameter;
a second aperture within said second portion having a second inner diameter, wherein said second aperture is concentric with said first aperture and opposite said first aperture;
a first bushing member having a first outer diameter positioned within said first aperture; and
a second bushing member having a second outer diameter positioned within said second aperture.

12. The flexible ski for use on a vehicle of claim 11, wherein said flexible elongate ski is comprised of a flexible plastic material.

13. The flexible ski for use on a vehicle of claim 11, wherein said flexible elongate ski is comprised of ultra high molecular weight polyethylene.

14. The flexible ski for use on a vehicle of claim 11, wherein said first inner diameter is equal to said second inner diameter.

15. The flexible ski for use on a vehicle of claim 11, wherein said first outer diameter and said second outer diameter are approximately equal to said first inner diameter and said second inner diameter respectively thereby providing a relatively tight fit for said bushing members.

16. The flexible ski for use on a vehicle of claim 11, wherein said first aperture and said second aperture have a circular shape, and wherein said first bushing member and said second bushing member have an outer circular shape corresponding to said apertures.

17. The flexible ski for use on a vehicle of claim 11, wherein said first aperture and said second aperture have a rectangular shape, and wherein said first bushing member and said second bushing member have an outer rectangular shape corresponding to said apertures.

18. The flexible ski for use on a vehicle of claim 11, wherein said bushing members are comprised of a metal material.

19. The flexible ski for use on a vehicle of claim 11, wherein the distal ends of said bushing members are substantially flush with a surface of said first portion and said second portion.

20. The flexible ski for use on a vehicle of claim 11, wherein the distal ends of said bushing members extend past a surface of said first portion and said second portion.
